(19) United States
(12) Patent Application Publication
(10) Pub. No.: US 2014/0040973 A1
(43) Pub. Date: Feb. 6, 2014

(54) METHOD FOR CONTROLLING INITIAL ACCESS RIGHTS TO OPEN MOBILE ALLIANCE DEVICE MANAGEMENT SERVERS

(71) Applicant: Kong Posh Bhat, Plano, TX (US)

(72) Inventor: Kong Posh Bhat, Plano, TX (US)

(73) Assignee: Samsung Electronics Co., Ltd., Suwon-si (KR)

(21) Appl. No.: 13/565,641

(22) Filed: Aug. 2, 2012

(51) Int. Cl. G06F 21/00

(52) U.S. Cl. 726/1; 726/3

(57) ABSTRACT

A client device and a server device communicate using an Open Mobile Alliance (OMA)-Device Management (DM) protocol. The client device is configured to grant the desired access rights to a newly bootstrapped DM server, upon successful completion of a bootstrap procedure, by using nodes in the Bootstrap Config Management Object (MO) to specify the access rights for different portions of the Management Tree.

### TECHNICAL FIELD

The present application relates generally to wireless communications systems and, more specifically, to procedures for assigning initial access rights to DM servers upon successful completion of the DM bootstrapping procedure.

### BACKGROUND

Each device that supports Open Mobile Alliance (OMA)-Device Management (DM) contains a Management Tree. The DM client resident on the device must expose the Management Tree to previously bootstrapped DM servers. The Management Tree organizes all available Management Objects in the device as a hierarchical tree structure where all nodes can be uniquely addressed with a Uniform Resource Identifier (URI). The OMA-DM specifications provide the following guidelines for the ACL (Access Control List) value of the root of the Management Tree.
The default value for the root ACL SHOULD be Add=*&Get=*. To ensure that any authenticated server always can extend the Management Tree, the root ACL value for the Add command SHOULD NOT be changed.

A consequence of the above listed requirement is that when a device is bootstrapped to a new DM server, by default, the new DM server is able to see all the direct nodes of the root of the Management Tree. In addition, the new DM server can create its own sub-tree under the root. By reading the ACL value of the root node, the new DM server is able to obtain the Server IDs of other bootstrapped DM servers, presenting a potential security risk in the case where multiple management authorities are involved. These problems had been masked by the fact that, prior to DM 1.3, most devices were managed by only one DM server.

### SUMMARY

A client device for use in a wireless communications network is provided. The client device includes a memory configured to store a plurality of instructions. The client device also includes processing circuitry capable of being configured to assign the default access rights to a DM server, upon successful completion of a bootstrap.

A server device for use in a wireless communications network is provided. The server device includes a memory configured to store a plurality of instructions. The server device also includes processing circuitry capable of configuring default access rights to a device management (DM) server on a device upon successful completion of a bootstrap procedure.

A method for use in a wireless communications network is provided. The method includes storing a plurality of instructions. The method also includes assigning default access rights to a DM server, upon successful completion of a bootstrap procedure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an OMA-DM transaction model according to this disclosure;

FIG. 2 illustrates a Management Tree according to this disclosure;

FIG. 3 illustrates a network topology view of the Device Management System according to embodiments of the present disclosure;

FIG. 4 illustrates the OMA-DM architecture according to embodiments of the present disclosure;

FIG. 5 illustrates a structure of a Bootstrap Config Management Object (MO) according to the present disclosure; and

FIG. 6 illustrates additional nodes for the Bootstrap Config MO according to embodiments of the present disclosure.

### DETAILED DESCRIPTION

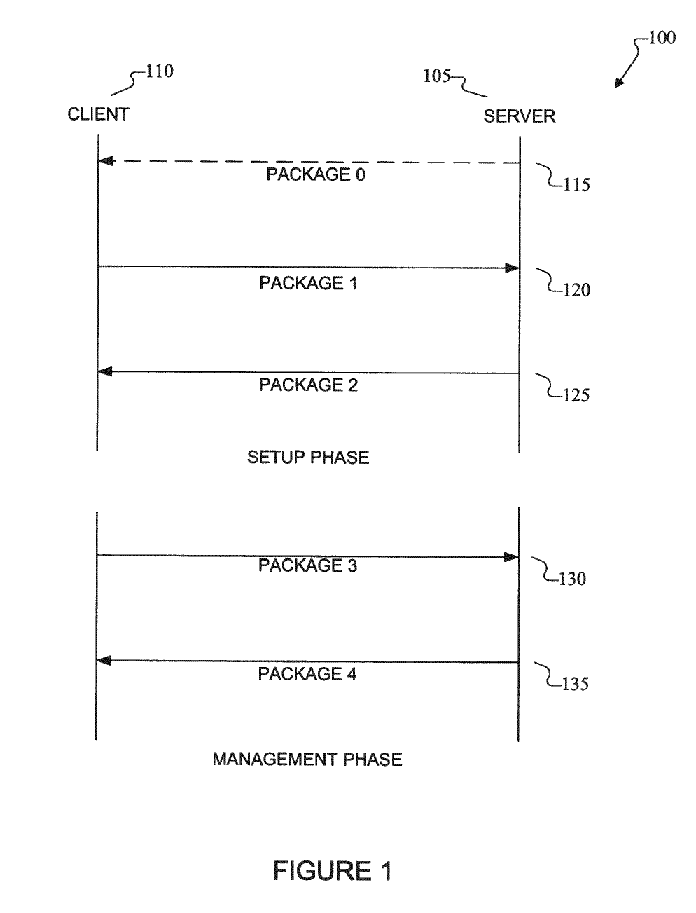

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

OMA-DM is a secure two-way management protocol that runs between a DM server 105 and a DM client 110 and it is used for remote management of devices. Historically the devices have been wireless devices; however OMA-DM has also started to address the remote management needs of wired devices. The OMA-DM protocol runs within the context of a DM session, using a request/response transaction model. Once a DM session is established, the DM server alternately sends commands to the Client and receives responses from the Client. The Client also informs the Sever about events that have occurred on the device, via Generic Alerts. The Management includes: Setting initial configuration information in devices; Subsequent installation and updates of persistent information in devices; Retrieval of management information from devices; Processing events and alarms generated by devices.

FIG. 1 illustrates an OMA-DM transaction model according to this disclosure. The embodiment of the OMA-DM transaction model 100 shown in FIG. 1 is for illustration only. Other embodiments could be used without departing from the scope of this disclosure.

A DM session consists of two phases: the setup phase followed by the management phase. The setup phase entails authentication and device information exchange.

OMA-DM supports the notion of Packages. A Package is a collection of related messages that are transferred between an originator and a recipient. Generally a Package consists of a single message. However, in cases where the information to be transferred between the originator and the recipient exceeds the size limitation of a DM message, the information can be sent over multiple messages within the same Package. Each message in a Package has to be responded to individually.

DM sessions are always initiated by the DM client. However, a Server can trigger the Client to initiate a session by sending an unsolicited message, known as the DM Notification, to the Client. The DM Notification “wakes up” the device and causes it to initiate a session with the requesting DM server. This message can be delivered over a variety of transports including SMS, HTTP and SIP.

In the setup phase, the DM server 105 sends an alert in package-0 115 to the client 110. The DM client 110 responds with package-1 120, which includes a client initialization with client credentials and device information. In response, the DM server 105 sends package-2 125: server initialization with server credentials, initial management operations or user interaction commands from the server. During the management phase, the DM server 105 issues commands which are processed by the DM client 110. The DM client 110 sends package-3 130: direct response to server management operations. The DM client 110 provides the status of the commands issued as well as any response that may be needed. The DM server 105 responds with package-4 135: more user interaction and management operations if the session is continued.

Normally a DM session ends when the DM server 105 sends an empty message (i.e. a message that does not contain any management operations or authentication challenges) to the DM client 110. However, either the DM client 110 or the DM server 105 can abort the session at any time.

With the exception of Package-0 115, all messages exchanged between the DM client 110 and the DM server 105 are Synchronization Markup Language (SyncML) messages. Conversely, Package-0 115 is a specially formatted binary message that is sent from the DM server 105 to the DM client 110. This message contains the DM server ID and it causes the DM client 110 to initiate a management session with the DM server 105.

The OMA-DM protocol supports DM Bootstrapping. Bootstrapping is the process by which a device moves from an un-provisioned, empty state, to a state where it is able to initiate a management session with authorized DM servers. DM clients 110 that have already been bootstrapped can be further bootstrapped to enable the device to initiate a management session to new DM servers 105.

OMA-DM defines various ways to perform the bootstrap process that include:

1) Customized bootstrap in which Devices are loaded with OMA DM account and connectivity information at manufacture, which is also referred to as factory bootstrap;

2) Bootstrap from smartcard in which the smartcard is inserted in the device and the DM client 110 is bootstrapped from the smartcard;

3) Over The Air bootstrap (aka Server initiated bootstrap) in which the DM server 105 sends out Bootstrap Message via some push mechanism, e.g. WAP Push or OBEX. The DM server 105 needs to receive the device address/phone number beforehand;

4) Client initiated bootstrap, over a secure HyperText Transfer Protocol (HTTPS).

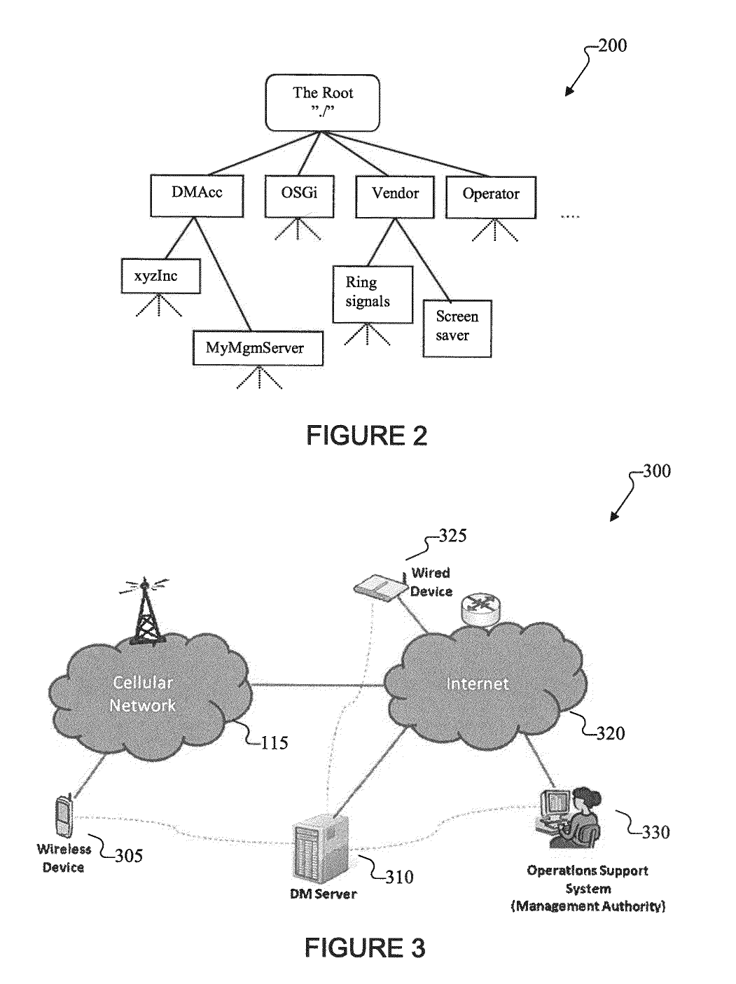

FIG. 2 illustrates a Management Tree according to this disclosure. The embodiment of the Management Tree 200 shown in FIG. 2 is for illustration only. Other embodiments could be used without departing from the scope of this disclosure.

To access the xyzInc node in the Management Tree 200, a server can present the address: ./DMAcc/xyzInc, or DMAcc/xyzInc. A Uniform Resource Indicator (URI) used in OMA DM can be case sensitive and node names are chosen such that resulting URI strings differ in more than just the case of individual letters. Implementations, even if treating and interpreting URIs as case insensitive, preserve the case of symbols in the names of dynamically created nodes.

Nodes are the entities that can be manipulated by management actions carried over the OMA DM protocol. A node can be as small as an integer or large and complex like a background picture or screen saver. The OMA DM protocol is agnostic about the contents, or values, of the nodes and treats the Leaf node values as opaque data.

An Interior node can have an unlimited number of child nodes linked to it. The complete collection of all nodes in a management database forms the tree 200 structure. Each node in the tree 200 has a unique URI and each node has properties associated with it. Table 1 illustrates example node properties and Table 2 illustrates support for the node properties. All properties, except the ACL, are valid only for the node to which they are associated.

TABLE 1
NODE PROPERTIES

| Property | Explanation |
|---|---|
| ACL | Access Control List. |
| Format | Specifies how node values should be interpreted. |
| Name | The name of the node in the tree. |
| Size | Size of the node value in bytes. |
| Title | Human readable name. |
| TStamp | Time stamp, date, and time of last change. |
| Type | The MIME type of a Leaf node's value or a URN |
| | representing the Management Object identifier for |
| | Interior nodes that root a Management Object sub- |
| | tree. |
| VerNo | Version number, automatically incremented at each |
| | modification. |

TABLE 2
SUPPORTED NODE PROPERTIES

| Property | Device Support |
|---|---|
| ACL | MUST |
| Format | MUST |
| Name | MUST |
| Size | MAY for Leaf nodes; |
| | MUST NOT for Interior nodes |
| Title | MAY |
| TStamp | MAY |
| Type | MUST |
| VerNo | MAY |

The ACL property has some unique characteristics when compared to the other properties. The access rights granted by an ACL are granted to Server Identifiers and not to the URI, IP address, or certificate of the DM server 105. The Server Identifier is an OMA DM specific name for a server. A Management Session is associated with a DM server Identifier through OMA DM authentication. All management commands received in one session are assumed to originate from the same DM server 105.

nodes in the Management Tree 200 can be either permanent or dynamic. Permanent nodes are typically built in at device manufacture. Permanent nodes can also be temporarily added to a device by, for instance, connecting new accessory hardware. However, the DM server 105 cannot create or delete permanent nodes at run-time. An attempt by a DM server 105 to delete a permanent node will return status Command not allowed. The same status code will also be returned for all attempts to modify the Name property of a permanent node. Dynamic nodes can be created and deleted at run-time by DM servers 105. The Add command is used to create new nodes. The Delete command is used to delete Dynamic nodes and all their properties. If a deleted node has children, i.e., is an Interior node, the children are also deleted. A permanent node can be the child of either a dynamic or a permanent node. In such cases, the permanent child node is created at the same time its parent node is created. The complete layout of the permanent nodes in the Management Tree 200 is reflected in the device description.

The complete structure of all nodes and the root (the device itself) forms the tree 200. nodes with the Format property set to node are defined as Interior nodes. nodes that are not Interior nodes are defined as Leaf nodes. Interior nodes can have 0 or more children; Leaf nodes cannot have children. DM servers 105 can explore the structure of the tree 200 by using the GET command. If the accessed node is an Interior node, a list of all child node names for which the requesting DM server 105 has the Get access is returned. If the Interior node has no children, an empty list of child node names is returned, e.g., <Data/>. If the node is a Leaf node it must have a value, which could be null, and this value is returned.

The Management Tree 200 can be extended at run-time. This is done with the Add or Replace command and both new Interior nodes and new Leaf nodes can be created. The parent of any new node is an Interior node. The device itself can also extend the Management Tree 200. This could happen as a result of user input or by attaching some kind of accessory to the device.

FIG. 3 illustrates a network topology view of the Device Management System according to embodiments of the present disclosure. The embodiment of the network 300 shown in FIG. 3 is for illustration only. Other embodiments could be used without departing from the scope of this disclosure.

The network 300 includes a wireless device 305 coupled to the DM server 310 through one or more of: a cellular network 315 and the Internet 320. In addition, a wired device 325 is coupled to the DM server 310 through the Internet 320. Target devices, such as wireless device 305 and wired device 325, include a memory configured to store instructions to execute processes for running the OMA-DM protocols and processing circuitry configured to execute the instructions and operate as a DM client. For example, the memory can store information regarding the tree, additional nodes and Table 3 described herein below. The DM server 310 includes a memory configured to store instructions to execute processes for running the OMA-DM protocols and processing circuitry configured to execute the instructions. The network 300 also includes an operations support system (OSS) 330, which is configured to perform the functions of a management authority. In the example shown in FIG. 3, solid lines represent physical connectivity and dotted lines represent logical connectivity. The DM protocol runs between the DM server 310 and the wireless device 305 in the Cellular Network 315 & between the DM server 310 and the wired device 325 connected to the Internet 320. The OSS 330 directs the device management operations on the target devices (e.g., wireless device 305 and wired device 325) via the DM server 310. Only the interaction between the DM server 310 and the DM client, which resides on the target devices (e.g., wireless device 305 and wired device 325), is within the scope of the OMA-DM specification.

The DM protocol defines three standard Management Objects (MOs) that all implementations support as described in OMA Device Management Standardized Objects—6 Mar. 2012, Open Mobile Alliance, OMA-TS-DM StdObj-V1_{—}3-20120306-C., (“StdObj Specification”) the contents of which are hereby incorporated by reference in their entirety. These are DMAcc (DM Account), DevInfo (Device Information) and DevDetail (Device Details).

The DMAcc MO is used to manage information pertaining to the bootstrapped DM servers. For each server that has been successfully bootstrapped for the device, the DMAcc MO maintains the following information (among other things):

DM server ID;

Connectivity information;

Server address; and

Server and client credentials.

The DevInfo MO provides basic information about the device. This includes:

Device ID;

Device manufacturer ID;

Model identifier; and

Language setting.

The DevDetail MO provides additional information about the device. This includes:

Device type;

Original Equipment Manufacturer;

Hardware version;

Firmware version;

Software version;

Indication whether the device supports optional features (e.g. large-object handling capability);

Maximum depth of the Management Tree;

Maximum total length of any URI;

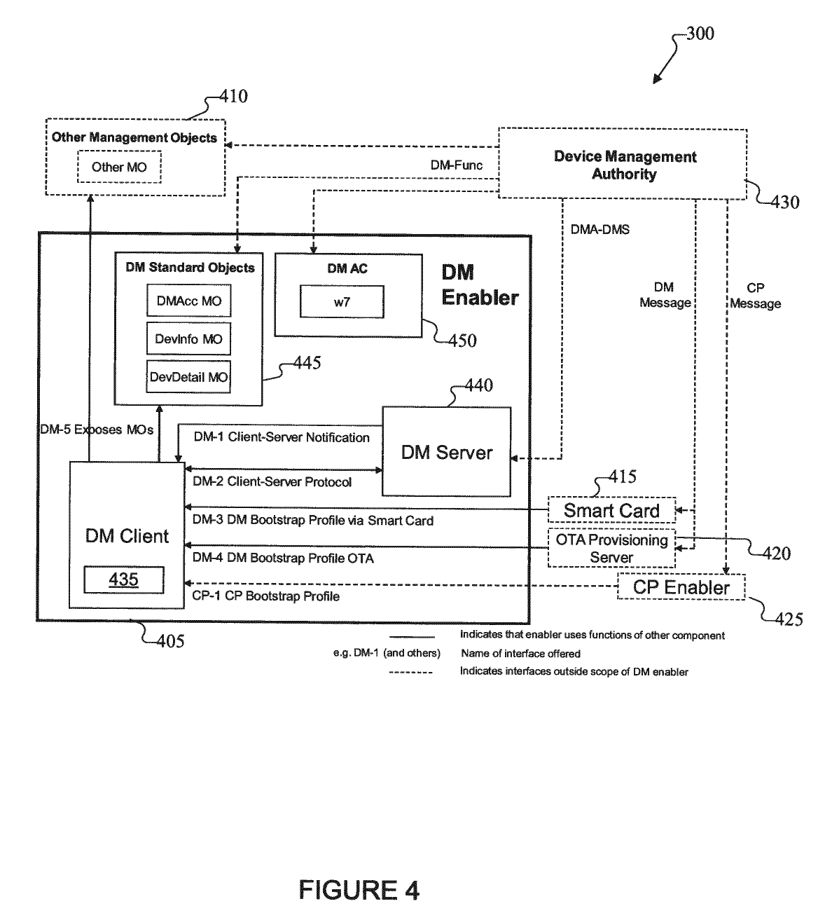

Maximum total length of any URI segment FIG. 4 illustrates the OMA-DM architecture according to embodiments of the present disclosure. The embodiment of the OMA-DM architecture 400 shown in FIG. 4 is for illustration only. Other embodiments could be used without departing from the scope of this disclosure. FIG. 4 describes the main entities in the OMA-DM System and identifies the major interfaces between them.

The OMA-DM architecture 400 manages aspects of the target device, such as wireless device 305 or wired device 325, and the server 310. The OMA-DM architecture 400 includes a DM enabler 405, which interfaces with other management objects 410, smart cards 415, OTA provisioning servers 420, Client Provisioning (CP) enabler 425 and the Device Management Authority 430. Aspects of the DM enabler 405 include the DM client 435, DM server 440, DM standard objects 445 and a Device Management Application Characteristic (DM AC) 450. A solid line indicates that the DM enabler 405 uses functions of another component. For example, the DM client 435 uses DM-1 client-server notification from DM server 440; the DM client 435 and DM server 440 exchange the exchange protocol messages; the DM client 435 gets bootstrapped to the DM server 440 via various means, such as by the smart card 415, the OTA provisioning server 420 or the CP enabler 425. The dashed lines indicate interfaces outside the scope of the DM enabler 405.

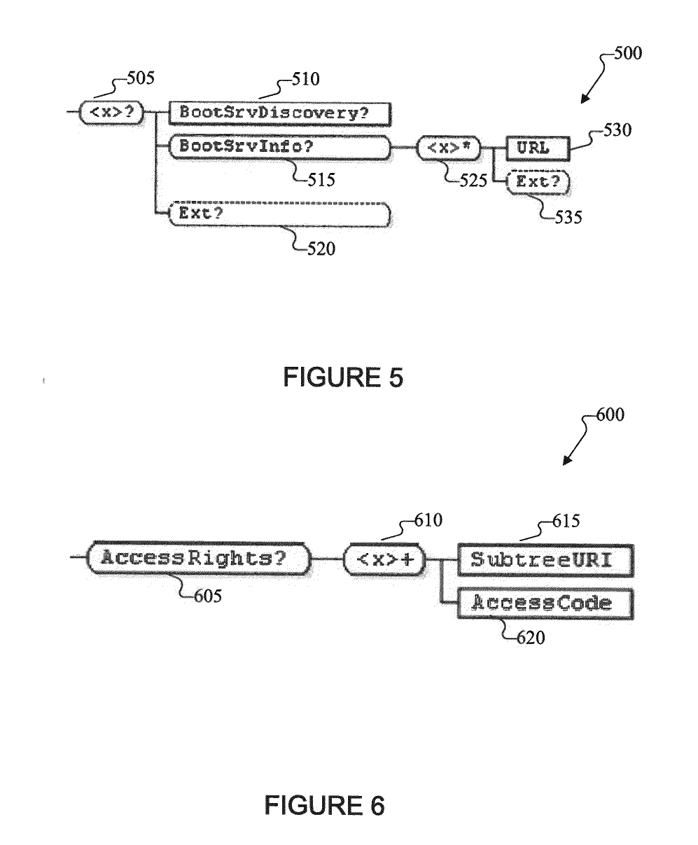

FIG. 5 illustrates a structure of a Bootstrap Config Management Object (MO) according to the present disclosure. The Bootstrap Config MO 500 shown in FIG. 5 is for illustration only. Other embodiments could be used without departing from the scope of this disclosure.

Embodiments of the present disclosure alter the default access rights for newly bootstrapped DM servers. According to embodiments of the present disclosure, the default access rights for newly bootstrapped DM servers are brought under management control by adding new nodes to the Bootstrap Config MO 500. The Bootstrap Config MO 500 includes a MO root node 505, a BootSrvDiscovery node 510, a BootSrvInfo node 515 and an Ext node 520. The BootSrvInfo node 515 further includes a placeholder node 525, Uniform Resource Locator (URL) 530 and Ext node 535.

FIG. 6 illustrates additional nodes for the Bootstrap Config MO according to embodiments of the present disclosure. The embodiment of the additional nodes 600 shown in FIG. 6 is for illustration only. Other embodiments could be used without departing from the scope of this disclosure.

In certain embodiments, the Bootstrap Config MO 500 is enhanced by adding the following nodes under the BootSrvInfo/<x> node 515: AccessRights node 605, a placeholder node 610, a SubtreeURI node 615 and an AccessCode node 620. In certain embodiments, the AccessRights node 605 is added under the MO root node 505.

The . . . /AccessRights 605 is an interior node that is the root node for all access rights information. If the AccessRights node 605 is not present, the initial ACL access rights are assumed to be as per the device policy. That is, the AccessRights node 605 is configured to indicate device specific rights as opposed to universal default rights. The device specific rights apply to all future DM servers to which the device is bootstrapped.

The . . . /AccessRights/<x> 610 is the root node for access rights information for one subtree within the Management Tree 200.

The . . . /AccessRights/<x>/SubtreeURI stores a URI value. The value of this leaf node is the URI of the root of a subtree within the Management Tree 200.

The . . . /AccessRights/<x>/AccessCode 620 stores a value associated with DM access rights. That is, the value of this leaf node (AccessCode node 620) indicates the DM access rights for the subtree which is rooted at the node whose URI is the value of the sibling SubtreeURI node. The valid value of this node is any value from Table 3, or any value obtained from the bit-wise ORing of the values in Table 3:

TABLE 3

| Access Type | Value |
|---|---|
| Get | 1 (i.e. 0x1) |
| Replace | 2 (i.e. 0x2) |
| Exec | 4 (i.e. 0x4) |
| Copy | 8 (i.e. 0x8) |
| Add | 16 (i.e. 0x10) |
| Delete | 32 (i.e. 0x20) |

For example, if the ACL rights are only Get, the value of the AccessCode node 620 is “1”. If the ACL rights are Get, Add and Delete, the value of the AccessCode node 620 is “49” (that is 1+16+32).

Addition of these nodes 600 to the Bootstrap Config MO 500 allows management authorities to manage the default access rights assigned to a DM server when the device is bootstrapped to the DM server. The management authorities can restrict the access rights of the DM server at either a subtree or an individual node level. Unlike the conventional case (i.e. prior to the additional nodes 600 illustrated by embodiments of the present disclosure), management authorities do not have to give blanket access for retrieval and new node addition at the Management Tree root level. Additionally, the management authorities can proscribe specialized access rights for different subtrees based on variations in the additional nodes.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network, a client device comprising:
a memory configured to store a plurality of instructions; and
processing circuitry configured to, in response to a bootstrapping of the client device to a server, perform a plurality of actions to grant initial access rights to the DM server by adding additional nodes to a Bootstrap Config Management Object (MO).

2. The client device as set forth in claim 1, wherein the additional nodes comprise an AccessRights node and at least one of: a placeholder node, a SubtreeURI node and an AccessCode node.

3. The client device as set forth in claim 2, wherein if the AccessRights node is not present, initial access rights are assumed to be as per a client device policy.

4. The client device as set forth in claim 2, wherein at least one node comprises a placeholder node configured as a root node for access rights information for one subtree within a Management Tree.

5. The client device as set forth in claim 4, wherein the placeholder node contains two child leaf nodes.

6. The client device as set forth in claim 5, wherein a first child leaf node is the AccessCode, and wherein the AccessCode comprises a value configured to indicate device management (DM) access rights to be assigned to a newly bootstrapped DM Server for a subtree that is rooted at a node whose uniform resource identifier (URI) is a value of a sibling SubtreeURI node.

7. The client device as set forth in claim 6, wherein the value of the AccessCode comprises at least one of: a value from a Table 1; and a value obtained from a bit-wise ORing of the values in Table 1, and wherein Table 1 is:

| Access Type | Value |
|---|---|
| Get | 1 (i.e. 0x1) |
| Replace | 2 (i.e. 0x2) |
| Exec | 4 (i.e. 0x4) |
| Copy | 8 (i.e. 0x8) |
| Add | 16 (i.e. 0x10) |
| Delete | 32 (i.e. 0x20) |

8. The client device as set forth in claim 5, wherein a second child leaf node is the SubtreeURI node, the SubtreeURI node comprises a value corresponding to a uniform resource indicator of the root of a subtree within the Management Tree.

9. For use in a wireless communications network, a server device comprising:
a memory configured to store a plurality of instructions; and
processing circuitry configured to assign the default access rights to a DM server on a device, upon successful completion of the bootstrap procedure.

10. The server device as set forth in claim 9, wherein the default access rights are assigned by adding additional nodes to a Bootstrap Config Management Object (MO) at the device, and wherein the additional nodes comprise an AccessRights node and at least one of: a placeholder node, a SubtreeURI node and an AccessCode node.

11. The server as set forth in claim 10, wherein if the AccessRights node is not present in the Bootstrap Config MO at the device, initial access rights are assumed to be as per a client device policy.

12. The server device as set forth in claim 10, wherein at least one node comprises a placeholder node configured as a root node for access rights information for one subtree within a Management Tree.

13. The client device as set forth in claim 12, wherein the placeholder node contains two child leaf nodes.

14. The server as set forth in claim 13, wherein a first child leaf node is the AccessCode, and wherein the AccessCode comprises a value configured to indicate device management (DM) access rights to be assigned to a newly bootstrapped DM Server for a subtree that is rooted at a node whose URI is a value of a sibling SubtreeURI node.

15. The server as set forth in claim 14, wherein the value of the Accesscode comprises at least one of: a value from a Table 1; and a value obtained from a bit-wise ORing of the values in Table 1, and wherein Table 1 is:

| Access Type | Value |
|---|---|
| Get | 1 (i.e. 0x1) |
| Replace | 2 (i.e. 0x2) |
| Exec | 4 (i.e. 0x4) |
| Copy | 8 (i.e. 0x8) |
| Add | 16 (i.e. 0x10) |
| Delete | 32 (i.e. 0x20) |

16. The server as set forth in claim 13, wherein a second child leaf node is the SubtreeURI node, the SubtreeURI node comprises a value corresponding to a uniform resource indicator of the root of a subtree within the Management Tree.

17. For use in a wireless communications network, a method comprising:
storing a plurality of instructions; and
assigning default access rights, by a client device, to a newly bootstrapped server, upon a successful completion of a bootstrap procedure, by adding additional nodes to a Bootstrap Config Management Object (MO).

18. The method as set forth in claim 17, wherein the additional nodes comprise an AccessRights node and at least one of: a placeholder node, a SubtreeURI node and an AccessCode node.

19. The method as set forth in claim 18, wherein if the AccessRights node is not present, an initial access rights are assumed to be as per a client device policy.

20. The method as set forth in claim 18, wherein at least one node comprises a placeholder node configured as a root node for access rights information for one subtree within a Management Tree and wherein the placeholder node contains two child leaf nodes.

21. The method as set forth in claim 20, wherein a first child leaf node is the AccessCode, and wherein the AccessCode comprises a value configured to indicate device management (DM) access rights to be assigned to a newly bootstrapped DM Server for a subtree that is rooted at a node whose URI is a value of a sibling SubtreeURI node.

22. The method as set forth in claim 21, wherein the value of the AccessCode comprises at least one of: a value from a Table 1; and a value obtained from a bit-wise ORing of the values in Table 1, and wherein Table 1 is:

| Access Type | Value |
|---|---|
| Get | 1 (i.e. 0x1) |
| Replace | 2 (i.e. 0x2) |
| Exec | 4 (i.e. 0x4) |
| Copy | 8 (i.e. 0x8) |
| Add | 16 (i.e. 0x10) |
| Delete | 32 (i.e. 0x20) |

23. The method as set forth in claim 20, wherein a second child leaf node is the SubtreeURI node, the SubtreeURI node comprises a value corresponding to a uniform resource indicator of the root of a subtree within the Management Tree.
